(19) United States
(12) Patent Application Publication
(10) Pub. No.: US 2006/0274130 A1
(43) Pub. Date: Dec. 7, 2006

(54) INK DISPENSING UNIT

(76) Inventors: Michael Self, Fort Lauderdale, FL (US); Avraham Bukai, Prague (CZ)

Correspondence Address: ROBERT M. SCHWARTZ, P.A., P.O. BOX 221470, HOLLYWOOD, FL, 33022, US

(21) Appl. No.: 11/422,632

(22) Filed: Jun. 7, 2006

Related U.S. Application Data
(60) Provisional application No. 60/688,316, filed on Jun. 7, 2005.

(51) Int. Cl. B41J 2/175

(52) U.S. Cl. 347/85

(57) ABSTRACT

An ink supply assembly for accommodating ink filled bottles containing ink for a printer. The assembly includes an ink well having a supply line for supplying ink from the ink well. An actuating device is disposed in the ink well. A lid assembly is configured to be attached to a mouth of the bottle. The lid assembly includes a valve that is actuated by the actuating device. A connector connects the supply line to the printer.

### CROSS-REFERENCE TO RELATED APPLICATIONS

This application claims the benefit of U.S. Provisional Application Ser. No. 60/688,316, filed on Jun. 7, 2005, entitled Ink Dispensing Unit; the prior application is herewith incorporated by reference in its entirety.

### BACKGROUND OF THE INVENTION

1. Field of the Invention

The present invention pertains to a dispensing unit that is used to dispense ink from a supplier provided bottle of ink to a printer head of an inkjet printer.

2. Description of the Related Art

Ink is usually supplied to the printer head by a disposable pouch that is filled with ink or by a refillable supply container. The pouch or container is connected to the ink head by a flexible tube that supplies the ink from the container to the printer head.

The ink pouches or containers are disposed on the printer at a height in relation to the printer head at which sufficient ink is supplied to the printer head to avoid starvation and at which excessive ink pressure to the printer head is prevented in order to stop ink from leaking out of the printer head. Separate ink pouches or containers are provided for each of the necessary colors for printing in color. The refillable pouches or containers include a sealable opening into which a funnel can be used to help refill the pouch or container.

The disadvantages of a pouch or container as described above are that the containers or pouches must be refilled. The containers are refilled by adding new ink via a funnel that is inserted into the sealable opening and pouring new ink into the container or pouch. This process is very time consuming and is very messy and hard to control. Furthermore, any ink that is spilled is wasted and cannot be used for printing. The spilled ink can also stain the surroundings (clothing, flooring, printer housing, etc. . . . ). Furthermore, the ink, which coats the funnel after filling, is wasted ink. The funnel must be cleaned between fillings of different colors, or different funnels must be provided for the different colors, in which case all the funnels must be cleaned after filling.

### SUMMARY OF THE INVENTION

It is accordingly an object of the invention to provide an ink dispensing unit for an inkjet printer that is more versatile and easier to use and overcomes the disadvantages disclosed above.

The dispensing unit includes a reservoir that allows a purchased ink container (bottle) to have an adapted lid assembly attached to it. The lid allows the container to be placed in an inverted position for allowing the ink to flow to the printer head. The lid assembly allows the container to be inverted and positioned to supply ink to the printer head without spilling ink and without using a funnel to refill an ink reservoir.

With the foregoing and other objects in view there is provided, an ink supply assembly for accommodating ink filled bottles containing ink for a printer. The assembly includes an ink well having a supply line for supplying ink from the ink well. An actuating device is disposed in the ink well. A lid assembly is configured to be attached to a mouth of the bottle. The lid assembly includes a valve that is actuated by the actuating device. A connector connects the supply line to the printer

In accordance with another feature of the invention, the valve is configured as a ball.

Other features which are considered as characteristic for the invention are set forth in the appended claims.

Although the invention is illustrated and described herein as embodied as ink dispensing unit for dispensing ink to an inkjet printer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a plan view of the ink dispensing unit according to the invention without the ink container in place;

FIG. 2 is a front elevational view of the ink dispensing unit according to the invention showing one ink container in place in the unit;

FIG. 3 is a side elevational view of the ink supply container with the adaptive lid of the ink dispensing unit according to the invention disposed on the container;

FIG. 4 is a plan view of the ink supply container with the adaptive lid of the ink dispensing unit according to the invention disposed on the container;

FIG. 5 is a side elevational view of the ink dispensing unit according to the invention;

FIG. 6 is an enlarged perspective view of the ink dispensing unit according to the invention;

FIG. 7 is a plan view of the inside of the adaptive lid of the ink dispensing unit according to the invention;

FIG. 8 is a perspective view of the a connector for connecting the ink dispensing unit according to the invention to a printer head supply line;

FIG. 9 is a sectional view through one of the ink wells of the ink dispensing unit according to the invention with a container in place.

### DESCRIPTION OF THE PREFERRED EMBODIMENTS

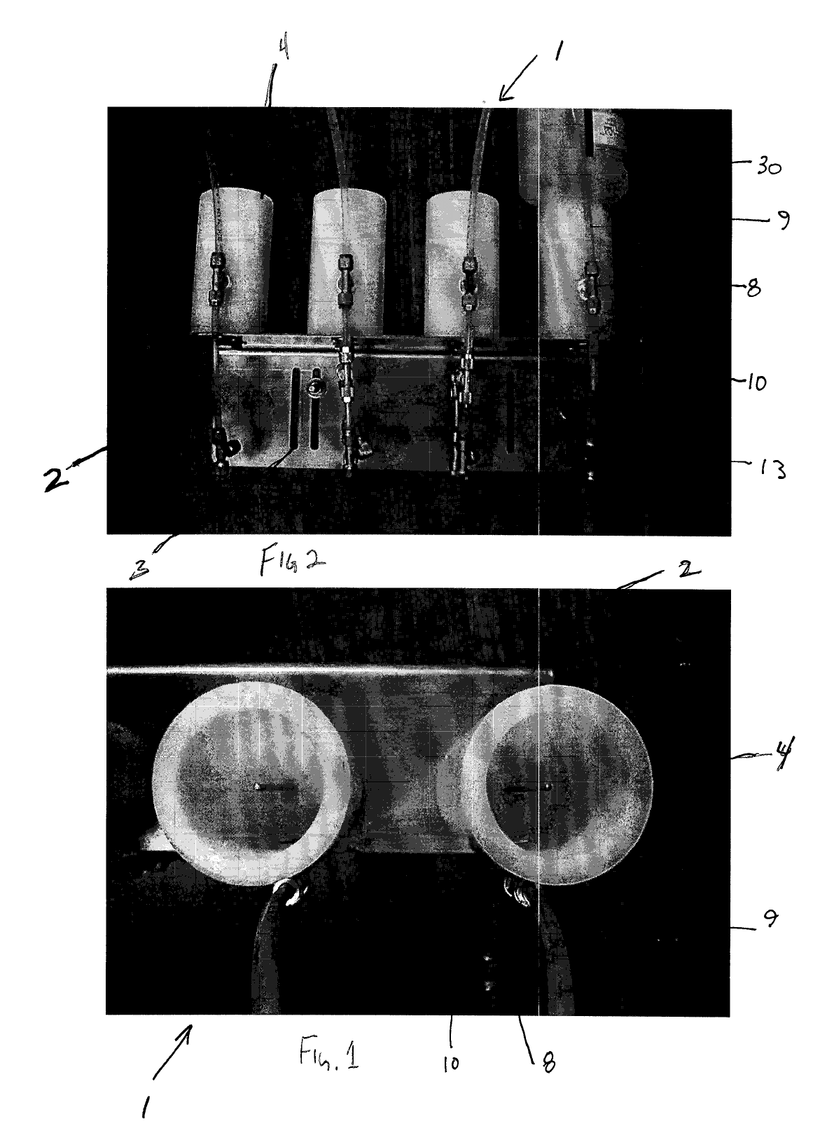

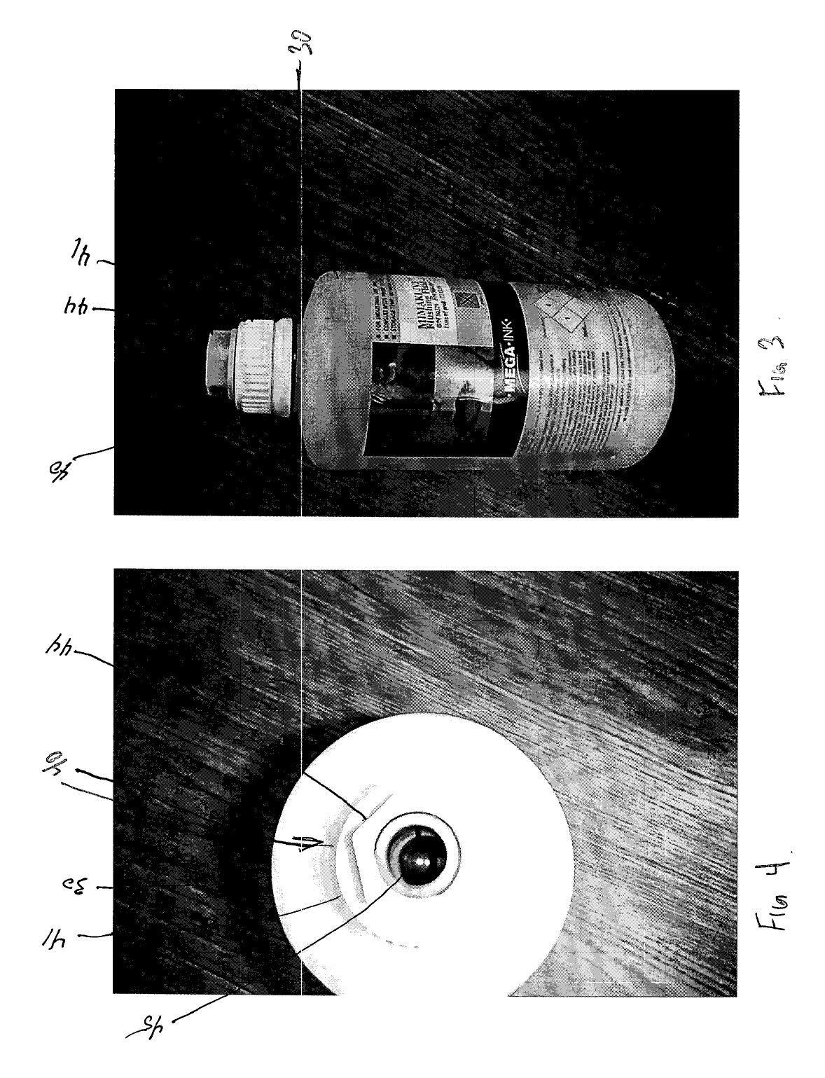

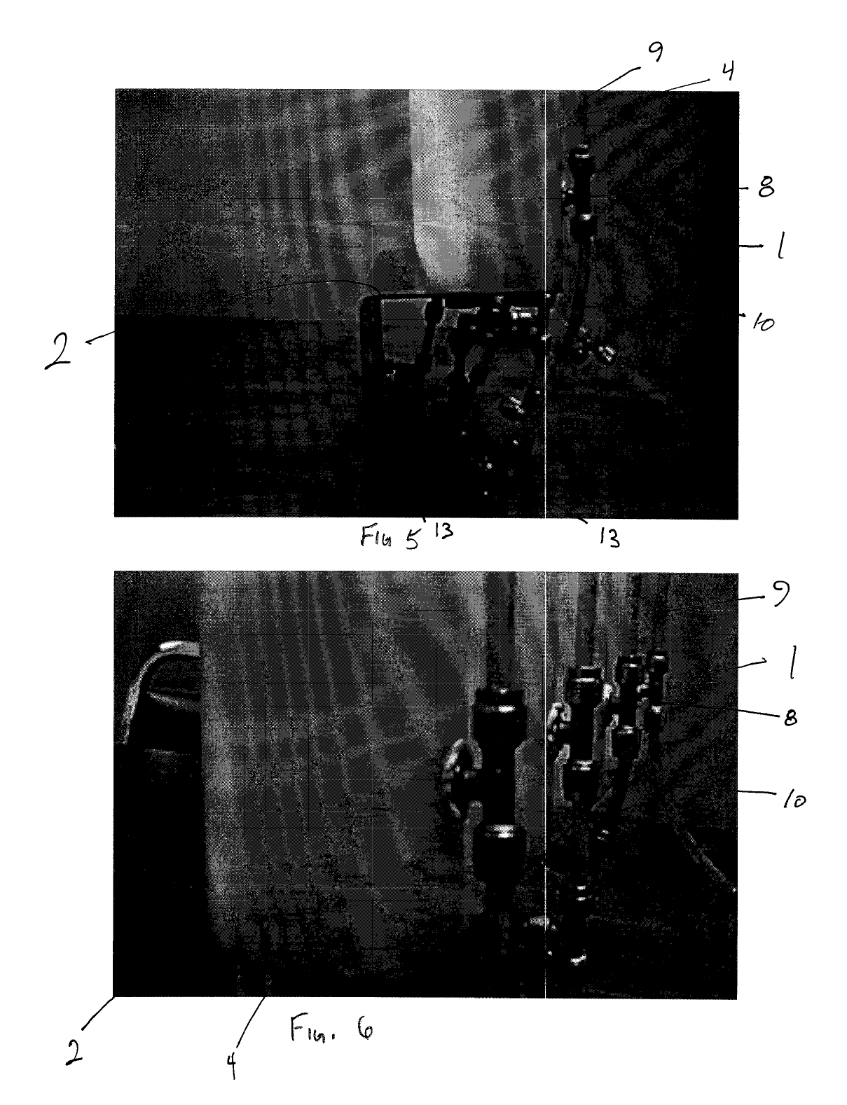

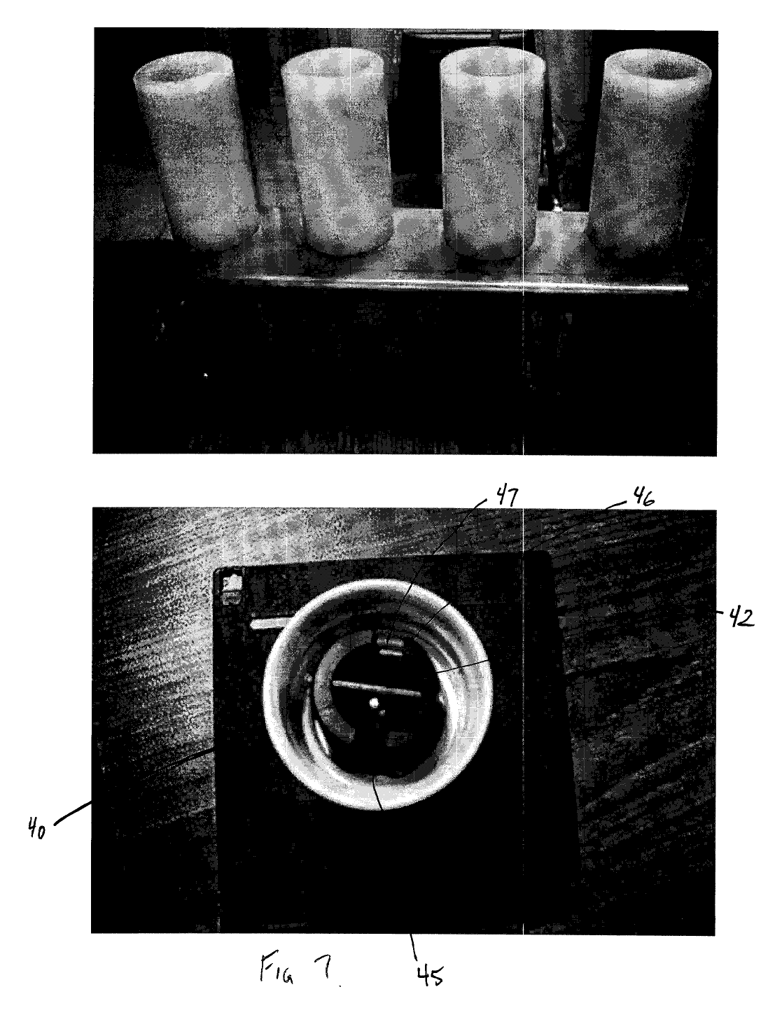

FIGS. 1 and 2 illustrate the ink supply unit 1 which has an L-shaped bracket 2, which allows the unit to be mounted on a printer (not shown). The bracket 2 includes elongated openings 3 which are used for adjusting the ink supply unit 1 to a proper height for dispensing ink. Attached to the bracket 2 are individual ink wells 4, four of which are included on the unit illustrated in FIG. 1, however the amount of ink wells 4 can be adjusted as required dependent on ink colors and printer heads that need to be supplied.

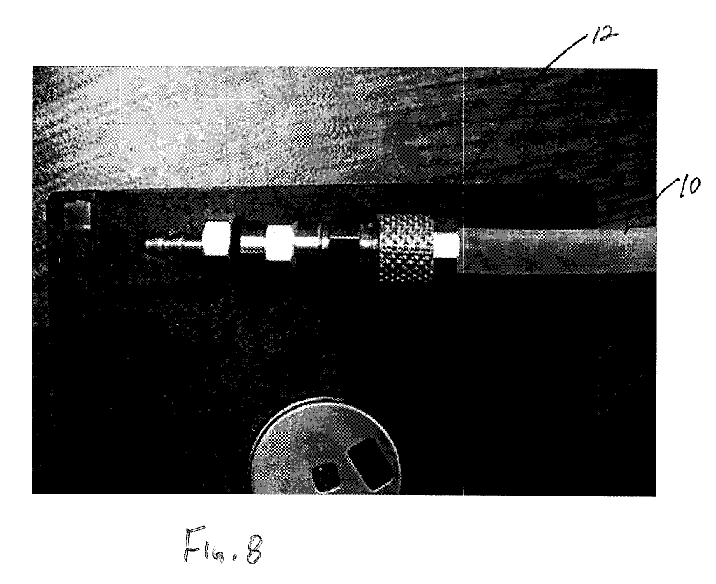

FIG. 3 shows a one liter bottle of ink 30 the bottle includes an opening with a having a male thread, which receives a lid for sealing the bottle 30. A lid assembly 40 is disposed on the bottle 30 which allows the bottle 30 to be placed in the appropriate ink well 4 without spilling the contents of the bottle. The construction of the lid assembly is seen in FIGS. 4, 7, and 9. The lid assembly 40 includes a lid 41 with a hole formed therein and a conduit 42 having two different diameters forming a shoulder, each diameter is provided with male threads. The conduit 42 is disposed in the hole of the lid and an o-ring 43 may be disposed between the shoulder of the conduit 42 and the lid 41. A nut 44 draws the shoulder of the conduit 42 onto the lid 41 and securely holds the conduit 42 in place. Another o-ring 43 may be disposed between the nut 44 and the lid 41. A ball 45, which acts as a valve, is disposed in the conduit 42, the ball 45 seats on the internal shoulder of conduit tube 42 when the conduit 42 is inverted. A pin 46 disposed across the larger diameter traps the ball 45 in the conduit 42. The larger diameter of the conduit has slots 47 formed therein for allowing the ink to flow into the conduit 42

The ink wells 4 are substantially cylindrical and have two diameters (FIG. 9). The first diameter corresponds to and accommodates the outside of the lid assembly 40 when the bottle 30 is disposed in its inverted ink dispensing position. The larger diameter of the ink well 4 corresponds to the diameter of the body of the bottle 30 and serves to prevent the bottle from being accidentally dislodged from the ink well 4. The ink well 4 includes a pin 6 disposed at the center axis of the ink well 4 and is coaxial with the center axis of the ink well 4. The pin 6 is of an adequate length to displace the ball 45 when the bottle 30 is placed on the ink well. A vent 7 is formed in the wall of the smaller diameter of the ink well 4 to prevent any build up of pressure or vacuum in the ink well 4.

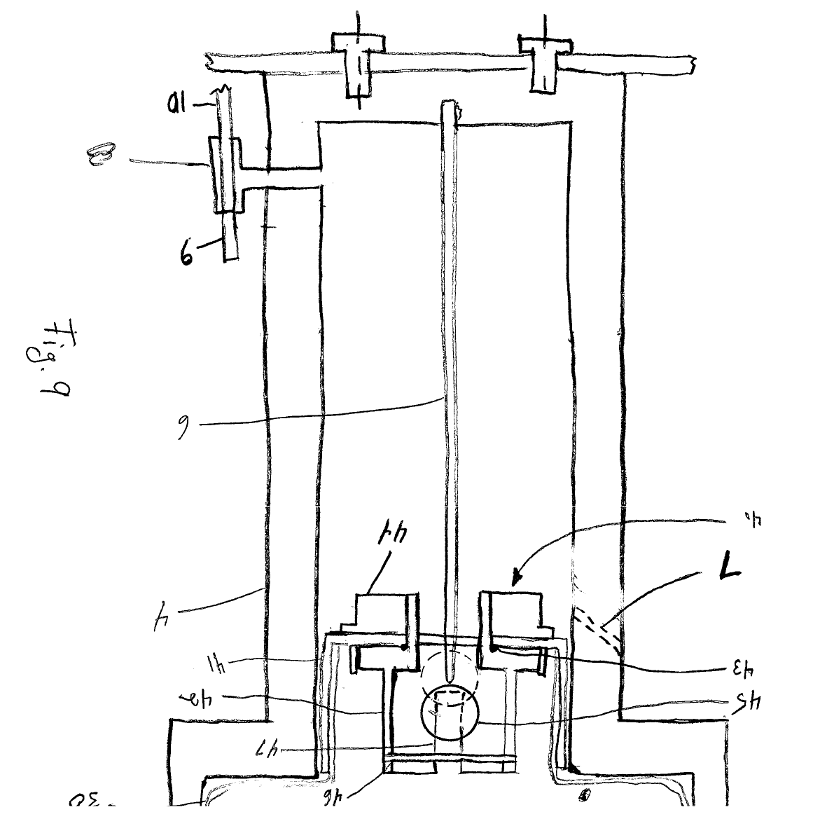

The ink wells 4 each have an opening formed therein in a bottom or lower area of the ink well 4. The opening receives a T-shape connector 8, which allows the ink to issue from the ink wells 4. A vent line 9 is connected to one end of the T-shaped connector 8 and supply line 10 is attached to the other end of the T-shaped connector 8. The supply line 10 includes has a connector 12 for connecting the supply line 10 to a printer (FIG. 8). Additional splitters 13 can be added to the supply line 10 to distribute the ink from a particular well 4 to several printing heads.

The method of using the ink supply unit 1 will be described. The ink supply unit 1 is mounted on the printer and adjusted to the appropriate height for delivering the correct amount of ink to the printer head. The supply line 10 is connected to the printer head or heads as required. A bottle 30 of ink is selected and the lid is removed from the bottle 30 and the lid assembly 40 is attached to the bottle 30. The bottle 30 is inverted and placed in the proper ink well 4. The pin 6 disposed in the ink well 4 displaces the ball 45 and allows the ink to flow into the ink well 4. The ink then flows from the ink well to the printer head via the supply line 10. After the bottle 30 is empty, the bottle 30 is removed and a new bottle 30 is provided by replacing the cap with the lid assembly 40.

I claim:

1. An ink supply assembly for accommodating ink filled bottles containing ink for a printer, the assembly comprising:
an ink well including a supply line for supplying ink from said ink well;
an actuating device disposed in said ink well;
a lid assembly configured for being to a mouth of the bottle, said lid assembly including a valve that is actuated by said actuating device; and
a connector for connecting said supply line to the printer.

2. The assembly according to claim 1, wherein said valve is configured as a ball.
